(19) United States
(12) Patent Application Publication
(10) Pub. No.: US 2007/0160849 A1
(43) Pub. Date: Jul. 12, 2007

(54) Powder coating composition suitable for thermo-sensitive substrates

(76) Inventors: Frank Niggemann, Pfaffenhofen (DE); Mike Schneider, Langenbach (DE); Phu Qui Nguyen, Moenchengladbach (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/642,375

(22) Filed: Dec. 19, 2006

Related U.S. Application Data
(60) Provisional application No. 60/751,858, filed on Dec. 20, 2005.

(51) Int. Cl. B32B 27/38; C08L 63/00; C08G 59/14

(52) U.S. Cl. 428/413; 525/524

(57) ABSTRACT

A powder coating composition obtained by homogeneous mixing of at least two separately produced powder coating compositions comprising (A) at least one powder coating base prepared from one or more glycidyl-functionalised (meth)acrylic resin, one or more di-carboxylic acid or the anhydrides thereof having an acid value in the range of higher 400 as hardener (cross-linker), together with at least one coating additive, and optionally pigment and/or filler, and (B) at least one powder coating base prepared from one or more glycidyl-functionalised (meth)acrylic resins, one or more hardeners (cross-linkers) having an acid value in the range of 100 to 400, together with at least one coating additive, and optionally pigment and/or filler, in a mixing ratio of component A) to component B) of 1:3 to 3:1, relative to the weight; the composition provides coatings with a desired gloss level and is curable at a temperature under 180° C.

### CROSS-REFERENCE TO RELATED APPLICATION

This application claims the benefit of U.S. Provisional Application Ser. No. 60/751,858 filed on Dec. 20, 2005 which is hereby incorporated by references in its entirety.

### FIELD OF THE INVENTION

The present invention is directed to a powder coating composition providing a gloss-controlled coating which is especially suitable for coating substrates and curing under lower temperature.

### DESCRIPTION OF PRIOR ART

Gloss-control and, especially, matting of powder coatings and keeping these superior technology properties of the coating are currently still difficult tasks.

The use of matting agents to adjust the gloss to the desired level is well known, see WO 03/102048, U.S. 2003/0134978, EP-A 1129788 and EP-A 0947254. Examples for such agents are waxes, silica, glass pearls, and crystalline resins. Such agents do not often react at curing temperatures below 180° C., and compositions often lead to coatings with a loss in technological properties.

Other techniques for forming a matting effect are the use of dry-blends of chemically incompatible powders or the use of different process conditions, such as, different curing conditions, such as, described in EP-A 0706834.

For example, WO200244289 describes a powder coating composition providing a gloss value of lower 55% which is prepared by dry-blending of a composition based on a glycidyl group containing acrylate resin and a carboxylic acid hardener and of a composition based on a carboxyl group containing material having an acid value in the range of 10 to 300. DE-A 2247779 claims matt powder coatings prepared by dry-blending of two powder coating compositions based on compositions comprising hardeners having different gel formation times.

However, the processes using such formulations are often difficult to control or are inefficient, and they do not provide coatings which may be cured at a lower temperature range. Therefore, there is a need to provide coating compositions suitable for powder coating applications on substrates which may be cured at a lower temperature range, also for temperature-sensitive substrates, and which result in gloss-controlled coatings.

### SUMMARY OF THE INVENTION

The present invention provides a powder coating composition obtainable by homogeneous mixing of at least two separately produced powder coating compositions as powder coating bases comprising

(A) at least one powder coating base prepared from one or more glycidyl-functionalised (meth)acrylic resin, one or more di-carboxylic acid or the anhydrides thereof having an acid value in the range of higher 400 as hardener (cross-linker), together with at least one coating additive, and optionally, pigment and/or filler, and

(B) at least one powder coating base prepared from one or more glycidyl-functionalised (meth)acrylic resins, one or more hardeners (cross-linkers) having an acid value in the range of 100 to 400, together with at least one coating additive, and optionally pigment and/or filler,

in a mixing ratio of component A) to component B) of 1:3 to 3:1, relative to the weight.

The powder coating composition of this invention provide coatings with a desired gloss level as well as coating properties, such as, high durability and smoothness. The composition of the invention is curable at a temperature under 180° C., and is therefore, especially suitable for coating applications on thermo-sensitive substrates.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

Slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

In components A) and B) glycidyl-functionalised (meth)acrylic resins as the principal binder resins are used.

The glycidyl-functionalised (meth)acrylic resins may be produced in a conventional manner from glycidyl (meth)acrylic monomers, as is, for example, described in D. A. Bates, The Science of Powder Coatings, volumes 1 & 2, Gardiner House, London, 1990, pages 62-70, and as known by the person skilled in the art.

Examples of glycidyl-functionalised (meth)acrylic resins are glycidyl-functionalised acrylic resins or copolymers thereof, for example, Almatex® PD 7610, Almatex® PD-1700 (Siber Hegner GmbH), WorléeCryl® CP 550 (Worlee Chemie GmbH), FINE-CLAD® WYR-903 (Reichold). Preferred are Almatex® PD 7610 and Almatex® PD-1700 for the use in component A), and WorléeCryl® CP 550 and FINE-CLAD® WYR-903 for the use in component B).

The glycidyl-functionalised (meth)acrylic resins have an epoxide equivalent weight (EEW) in a range of 300 to 2000, epoxy equivalent weight determined by means of ADSAM 142, a method code of the EEW test using auto-tritator (Brinkman Metrohm 751 GPD Titrino) and known by a person skilled in the art, and a glass transition temperature Tg in a range of, e.g., 30 to 80° C., preferably 40 to 70 Tg determined by means of differential scanning calorimetry (DSC).

The glycidyl-functionalised (meth)acrylic resins may be partially replaced by further resins, such as, for example, diglycidyl ethers of bisphenol, epoxy novolak and other resins containing epoxy groups, in quantities in the range of lower than 10 wt %, based on component A).

As hardener in component A), one or more di-carboxylic acids or the anhydrides thereof are used. The di-carboxylic acids or the anhydrides thereof have an acid value in the range of higher 400, preferably, in the range of 410 to 600. Examples are di-carboxylix acids with a number of carbon atoms C in the range of 4 to 20, preferably, 10 to 18.

As hardener in component B) one or more hardeners having an acid value in the range of 100 to 400, preferably, in the range of 250 to 350, are used.

Such hardeners are conventional agents containing carboxyl groups, such as, polycarboxylic acids or the anhydrides thereof, which are different from the one of component A), carboxyl group containing polyesters, carboxyl group containing (meth)acrylates, polyols. Examples are C12-dodecanedioic acid and Additol® P 791.

Preferred for this invention are C12-dodecanedioic acid in component A) and Additol® P 791 in component B).

The acid value is defined as the number of mg of potassium hydroxide (KOH) required to neutralise the carboxylic groups of 1 g of the resin.

The hardeners of components A) and B) may be partially replaced by further hardeners useful for the curing of epoxy resins, such as, for example, hardeners containing amid or amino groups, for example, dicyandiamide and the derivatives thereof, in quantities in the range of lower than 10 wt %, based on each of components A) and B).

The powder coating bases of A) and of B) may contain as further components the constituents conventional in powder coating technology, such as, additives, pigments and/or fillers as known by a person skilled in the art.

Additives are, for example, degassing auxiliaries, flow-control agents, flatting agents, texturing agents, fillers (extenders), photo-initiators, catalysts, dyes. Examples are flow-control agents incorporated in the composition according to the invention via an inorganic carrier or by master-batch techniques known by a person skilled in the art. Compounds having anti-microbial activity may also be added to the powder coating compositions.

The cross-linking reaction may be additionally accelerated by the presence in the powder coating composition according to the invention of catalysts known from thermal cross-linking. Such catalysts are, for example, tin salts, phosphides, amines and amides. They may be used, for example, in quantities of 0.02 to 3 wt %, based on the total weight of the powder coating composition.

The powder coating base A) and B) may contain transparent, color-imparting and/or special effect-imparting pigments and/or fillers (extenders). Suitable color-imparting pigments are any conventional coating pigments of an organic or inorganic nature. Examples of inorganic or organic color-imparting pigments are titanium dioxide, micronized titanium dioxide, carbon black, azopigments, and phthalocyanine pigments. Examples of special effect-imparting pigments are metal pigments, for example, made from aluminum, copper or other metals, interference pigments, such as, metal oxide coated metal pigments and coated mica. Examples of usable extenders are silicon dioxide, aluminum silicate, barium sulfate, and calcium carbonate.

The above constituents (additives, pigments and/or fillers) are used in conventional amounts known to the person skilled in the art, for example, 0.01 to 30 wt %, based on the total weight of each powder coating base, preferably 0.01 to 20 wt %.

Component A) contains, for example, 30 to 90 wt % of one or more glycidyl-functionalised (meth)acrylic resin, 1 to 30 wt % of one or more di-carboxylic acids or the anhydrides thereof having an acid value in the range of higher 400 as hardener (cross-linker), 0.1 to 10 wt % of least one coating additive and 0 to 30 wt % pigment and/or filler.

Component B) contains, for example, 30 to 90 wt % of one or more glycidyl-functionalised (meth)acrylic resin, 1 to 30 wt % of one or more hardeners (cross-linkers) having an acid value in the range of 100 to 400, 0.1 to 10 wt % of least one coating additive and 0 to 30 wt % pigment and/or filler.

The powder coating bases of A) and of B) are separately prepared by conventional manufacturing techniques used in the powder coating industry, such as, extrusion and/or grinding processes, known by a person skilled in the art.

For example, the ingredients of each powder coating base can be blended together by dry-blending methods and then ground to a fine powder, which can be classified to the desired grain size, for example, to an average particle size of 20 to 200 μm. The blended ingredients can be heated furthermore to a temperature to melt the mixture, and then the mixture is extruded. The extruded material is then cooled on chill roles, broken up and then ground to a fine powder, which can be classified to the desired grain size.

Each powder coating base may also be prepared by spraying from supercritical solutions, AND “non-aqueous dispersion” processes or ultrasonic standing wave atomization process.

Furthermore, specific components of the powder coating base according to the invention, for example, additives, pigment, fillers, may be processed with the finished powder coating particles after extrusion and grinding by a “bonding” process using an impact fusion. For this purpose, the specific components may be mixed with the powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g., the glass transition temperature Tg of the composition, in a range, of, e.g., 50 to 60° C. After cooling the mixture the desired particle size of the resulted particles may be proceed by a sieving process.

The powder coating base of component A) and the powder coating base of component B) may be mixed together in a mixing ratio of component A) to component B) of 1:3 to 3:1, preferably of 1:2 to 2:1, relative to weight.

Such a preferred powder coating composition may provide powder coatings with a low or medium gloss.

The gloss of finishes according to this invention is measured at 60° angle according to DIN 67 530 and can be adjusted in the range of 1 to 95 gloss units by using the composition according to the invention. Typically, a low gloss (matt finish) has a gloss in the range of 1 to 30 gloss units and a medium gloss finish in the range of 30 to 60 gloss units.

The present invention also provides a process, in which a powder coating composition comprising

(A) at least one powder coating base prepared from one or more glycidyl-functionalised (meth)acrylic resin, one or more di-carboxylic acids or the anhydrides thereof having an acid value in the range of higher 400 as hardener (cross-linker), together with at least one coating additive, and optionally pigment and/or filler, and

(B) at least one powder coating base prepared from one or more glycidyl-functionalised (meth)acrylic resins, one or more hardeners (cross-linkers) having an acid value in the range of 100 to 400, together with at least one coating additive, and optionally, pigment and/or filler,

in a mixing ratio of component A) to component B) of 1:3 to 3:1, relative to the weight,

is produced in such a manner that component A) and component B) are initially produced separately using conventional powder coating production processes, and the two components A) and B) in the stated mixing ratio are then subjected to a further operation, for example, a dry-blending or an extrusion operation, to ensure homogeneous mixing of the two components.

The powder coating composition of this invention may be applied by, e.g., electrostatic spraying, thermal or flame spraying, or fluidized bed coating methods, also, coil coating techniques, all of which are known to those skilled in the art.

The coating compositions may be applied to, e.g., metallic substrates, non-metallic substrates, such as, paper, wood, plastics, glass and ceramics, as a one-coating system or as coating layer in a multi-layer film build. In certain applications, the substrate to be coated may be pre-heated before the application of the powder composition, and then either heated after the application of the powder or not. For example, gas is commonly used for various heating steps, but other methods, e.g., microwaves, IR or NIR are also known.

The powder coating compositions according to the invention can be applied directly on the substrate surface or on a layer of a primer which can be a liquid or a powder based primer. The powder coating compositions according to the invention can also be applied as a coating layer of a multilayer coating system based on liquid or powder coats, for example, based on a powder or liquid clear coat layer applied onto a color-imparting and/or special effect-imparting base coat layer or a pigmented one-layer powder or liquid top coat applied onto a prior coating.

The applied and melted powder coating layer can be cured by thermal energy. The coating layer may, for example, be exposed by convective, gas and/or radiant heating, e.g., infra red (IR) and/or near infra red (NIR) irradiation, as known in the art, to temperatures of, e.g., 100° C. to 200° C., preferably of 120° C. to 180° C. (object temperature in each case).

The powder coating composition can also be cured by high energy radiation known by a skilled person. UV (ultraviolet) radiation or electron beam radiation may be used as high-energy radiation. UV-radiation is preferred. Irradiation may proceed continuously or discontinuously.

Dual curing may also be used. Dual curing means a curing method of the powder coating composition according to the invention where the applied composition can be cured, e.g., both by UV irradiation and by thermal curing methods known by a skilled person.

The present invention is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

The following Examples illustrate the invention.

### EXAMPLES

### Example 1

Manufacture of a Powder Coating Composition and Application

A powder coating composition according to the invention (Formulation 1) is prepared according to the following ingredients:

Formulation 1

| Component A | Weight % | Component B | Weight % |
|---|---|---|---|
| Almatex ® PD 7610 | 70 | WorléeCryl ® CP 550 | 70 |
| (EEW: 510-560) | | (EEW: 510-550) | |
| Dodecane dicarboxylic | 27 | Additol ® P 791 | 25.5 |
| acid (acid value 420) | | (dicarboxylic acid, | |
| | | acid value 280-350) | |
| Resiflow ® PV 88 | 2.0 | Additol ® P 824 | 3.5 |
| (flow agent) | | (flow agent) | |
| Benzoin | 1.0 | Benzoin | 1.0 |

The ingredients of each component A) and of each component B) are separately mixed together and separately extruded in an extruder PR 46 (firm:Buss AG) at 120° C. The melt-mixed formulation is cooled and the resulted material is grinded to a D50 value of 40 μm particle size distribution.

The final powder composition is resulted by mixing of 50 wt % of component A) and 50 wt % of component B) via dry-blending to ensure homogeneous mixing.

The final powder composition is applied to a metal sheet by electrostatic spraying to a film thickness of 80 μm. Finally the coating is cured in a convection oven at 170° C. for 10 minutes.

### Example 2

Testing of the Coating

TABLE 1

| | Erichsen | | Gassing | Low |
|---|---|---|---|---|
| | Cupping | Adhesion | (Pinholes, | Gloss |
| | DIN EN ISO | DIN EN ISO | visual | DIN |
| | 1520 | 2409 | observation) | 67530 |
| Formulation 1 | 5 mm | Gt0 | no | 30 |

The results show a very high durability of the coating as well as a superior adhesion on metal substrates after the curing at lower temperature at 170° C. No pinholes are noticed, and a low gloss value of the coating is obtained.

What is claimed is:

1. A powder coating composition obtainable by homogeneous mixing of at least two separately produced powder coating compositions as powder coating bases comprising
(A) at least one powder coating base prepared from one or more glycidyl-functionalised (meth)acrylic resin, one or more di-carboxylic acid or the anhydrides thereof having an acid value in the range of higher 400 as hardener (cross-linker), together with at least one coating additive, and optionally pigment and/or filler, and
(B) at least one powder coating base prepared from one or more glycidyl-functionalised (meth)acrylic resins, one or more hardeners (cross-linkers) having an acid value in the range of 100 to 400, together with at least one coating additive, and optionally pigment and/or filler,
in a mixing ratio of component (A) to component (B) of 1:3 to 3:1, relative to the weight.

2. The composition according to claim 1 wherein the glycidyl-functionalised (meth)acrylic resin in Component (A) and (B) having a glass transition temperature in a range of 30 to 80° C.

3. The composition according to claim 1 wherein the hardener in component (A) having an acid value in the range of 410 and 600, and a number of carbon atoms C in the range of 4 to 20.

4. The composition according to claim 1 wherein the hardener in component (B) having an acid value in the range of 250 to 350.

5. The composition according to claim 1 wherein component (A) comprising 30 to 90 wt % of one or more glycidyl-functionalised (meth)acrylic resin, 1 to 30 wt % of one or more di-carboxylic acid or the anhydrides thereof having an acid value in the range of higher 400 as hardener (cross-linker), 0.1 to 10 wt % of least one coating additive and 0 to 30 wt % pigment and/or filler, the wt % based on component (A).

6. The composition according to claim 1 wherein component (B) comprising 30 to 90 wt % of one or more glycidyl-functionalised (meth)acrylic resin, 1 to 30 wt % of one or more hardeners (cross-linkers) having an acid value in the range of 100 to 400, 0.1 to 10 wt % of least one coating additive and 0 to 30 wt % pigment and/or filler the wt % based on component (B).

7. Preparation of the composition of claim 1 comprising the steps preparation of the powder coating base (A) and the powder coating base (B) separately and afterwards mixed together.

8. Preparation of the composition of claim 7 wherein mixing component (A) and (B) in a mixing ratio of 1:2 to 2:1, relative to the weight.

9. Coated substrate coated with the composition according to claim 1 and cured.
